(19) United States
(12) Patent Application Publication
(10) Pub. No.: US 2015/0083533 A1
(43) Pub. Date: Mar. 26, 2015

(54) CUSTOMIZED FRICTION FOR BRAKES

(71) Applicant: Otis Elevator Company, Farmington, CT (US)

(72) Inventors: Tahany Ibrahim El-Wardany, Bloomfield, CT (US); Wayde R. Schmidt, Pomfret Center, CT (US); Xiaodong Luo, South Windsor, CT (US); Anthony Cooney, Unionville, CT (US); John T. Pitts, Avon, CT (US)

(73) Assignee: Otis Elevator Company, Farmington, CT (US)

(21) Appl. No.: 14/397,568

(22) PCT Filed: Apr. 30, 2012
(86) PCT No.: PCT/US12/35743

§ 371 Date: Oct. 28, 2014

(51) Int. Cl. F16D 69/02

(52) U.S. Cl. CPC F16D 69/026; F16D 69/023; F16D 2200/0065; F16D 2200/0047; F16D 2250/0084
USPC 188/251 A; 29/428

(57) ABSTRACT

A brake element is provided including a friction material. The friction material includes a polymer-based ceramic matrix composite material having a plurality of fibers. The plurality of fibers is arranged at an angle to a braking direction.

### CROSS REFERENCE TO RELATED APPLICATIONS

This application claims the benefit of PCT International Application Serial No. PCT/US2012/35743 filed on Apr. 30, 2012, the contents of which are incorporated herein by reference thereto.

### BACKGROUND OF THE INVENTION

Exemplary embodiments generally relate to braking systems, such as those used to slow and/or stop an elevator car or counterweight, for example in an over speed condition. More particularly, the embodiments can relate to an elevator safety brake system having a composite friction surface.

A typical safety braking system is attached to an elevator car and comprises a pair of wedge-shaped brake shoes having substantially flat or grooved frictional surfaces. These frictional surfaces are ordinarily positioned on opposite sides of the stem portion of a T-shaped guide rail supported on an elevator hoistway wall. These wedge-shaped brake shoes are activated by a governor mechanism which forces the wedge-shaped brake shoes along an adjacent guide shoe assembly which in turn forces the frictional surfaces of the brake shoes to make contact with the guide rail to slow or stop the car.

As very tall buildings are built, high speed and high load elevators have become necessary to service the numerous floors in such buildings. The safety braking requirements of such elevators have become increasingly demanding. It has been determined that conventional cast iron is not preferable as a consistent friction material at high speeds and loads required by such modern elevator systems because of the excessive heat generation during sliding. Consequently, conventional cast iron may have issues such as excessive wear and instability of coefficient of friction caused by the high frictional heating.

### BRIEF DESCRIPTION OF THE INVENTION

According to one embodiment of the invention, a brake element is provided including a friction material. The friction material includes a polymer-based ceramic matrix composite material having a plurality of fibers. The plurality of fibers is arranged at an angle to a braking direction.

Alternatively, in this or other aspects of the invention, the brake element has a coefficient of friction greater than 0.3 when the plurality of fibers are at an angle of about 90 degrees.

Alternatively, in this or other aspects of the invention the brake element is an insert on a brake shoe.

Alternatively, in this or other aspects of the invention, the brake element is used in combination with one or more other brake elements.

Alternatively, in this or other aspects of the invention, one of the brake elements has a length or width different from another brake element.

Alternatively, in this or other aspects of the invention, the one or more brake elements have a uniform and equal thickness.

Alternatively, in this or other aspects of the invention, the friction material is mechanically attached to a surface of the brake shoe.

Alternatively, in this or other aspects of the invention, the friction material is chemically attached to a surface of the brake shoe.

Alternatively, in this or other aspects of the invention, the polymer-based ceramic matrix composite material includes a matrix phase of a silicon carbide phase, a silicon oxycarbide phase, and/or a carbon phase.

Alternatively, in this or other aspects of the invention, the polymer-based ceramic matrix composite material includes a reinforcement phase of a silicon carbide and/or a carbon.

Alternatively, in this or other aspects of the invention, the brake element is part of an elevator safety brake system for stopping an elevator car or counterweight.

According to an alternate embodiment of the invention, a method is provided for making a brake element including providing a friction material. The friction material include a polymer based ceramic matrix composite material having a plurality of fibers. The plurality of fibers are arranged at an angle to a braking direction.

Alternatively, in this or other aspects of the invention, the polymer-based ceramic matrix composite material includes a matrix phase of a silicon carbide phase, a silicon oxycarbide phase, and/or a carbon phase.

Alternatively, in this or other aspects of the invention the friction material is an insert on the first surface.

Alternatively, in this or other aspects of the invention, the polymer-based ceramic matrix composite material includes a reinforcement phase of a silicon carbide and/or a carbon.

Alternatively, in this or other aspects of the invention, the plurality of fibers is arranged by selecting an angle such that the friction material provides a desired coefficient of friction.

Alternatively, in this or other aspects of the invention, the angle is 90 degrees.

Alternatively, in this or other aspects of the invention, the desired coefficient of friction is greater than or equal to 0.3.

### BRIEF DESCRIPTION OF THE DRAWINGS

The subject matter, which is regarded as the invention, is particularly pointed out and distinctly claimed in the claims at the conclusion of the specification. The foregoing and other features, and advantages of embodiments of the invention are apparent from the following detailed description taken in conjunction with the accompanying drawings in which:

FIG. 1 is a cross-sectional view of a machine room-less elevator system in a hoistway;

FIG. 2 is a side view of an elevator brake shoe according to an exemplary embodiment of the invention; and

FIGS. 3a-3c are front views of exemplary elevator brake shoes according to exemplary embodiments of the invention.

The detailed description explains embodiments of the invention, together with advantages and features, by way of example with reference to the drawings.

### DETAILED DESCRIPTION OF THE INVENTION

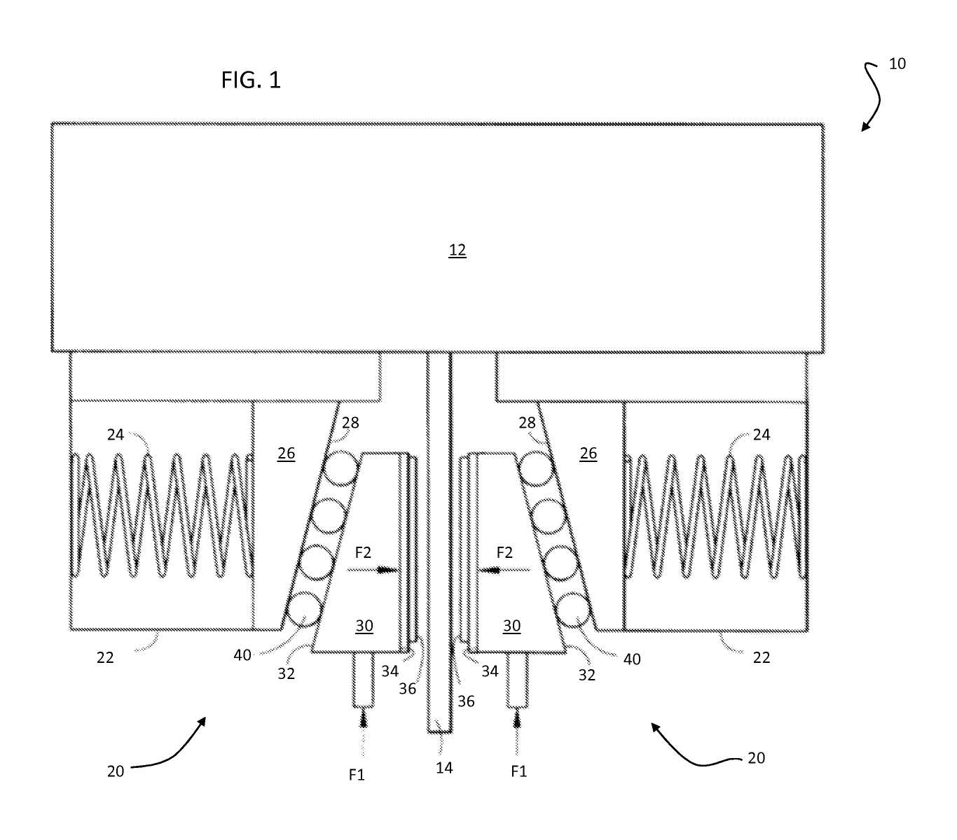

Referring now to FIG. 1, a simplified schematic diagram of an elevator safety brake system 10 is illustrated. The brake system 10 comprises a pair of actuators 20 which are attached to an elevator car 12 on opposing sides of a guide rail 14 supported in an elevator hoistway (not shown). Each actuator 20 includes a wedge-shaped guide shoe 26 which is movable within a housing 22 in a direction generally perpendicular to the guide rail 14. The guide shoe 26 is biased in the direction of the guide rail 14 by a coil spring 24. The surface 28 of the guide shoe 26 facing the guide rail 14 is inclined. The actuator 20 additionally includes a wedge-shaped brake shoe 30 having a similar inclined surface 32 complementary to the inclined surface 28 of the guide shoe 26. The brake shoe 30 is also provided with a surface 34 opposite the inclined surface 32, and facing the guide rail 14. The brake shoe 30 is located between the guide shoe 26 and the guide rail 14. A brake pad 36 having a high friction material is attached to the surface 34 of the brake shoe 30 facing the guide rail 14. A plurality of rollers 40 is positioned between the inclined surface 28 of the guide shoe 26 and the complementary inclined surface 32 of the brake shoe 30. The rollers 40 provide a low friction contact between the adjacent inclined surfaces 28, 32 of the guide shoe 26 and brake shoe 30 respectively. The guide shoe 26, biased by spring 24, applies a normal force F2 in the direction of the guide rail 14 on the brake shoes 30 through the rollers 40.

In an emergency situation wherein the application of the brake system 10 is desired, a force F1 in the direction of the elevator car is applied to the bottom of the brake shoes 30, causing them to move towards the elevator car 12. In one embodiment, this force may be applied by a rope, cable, or mechanical linkage connected to a governor (not shown). The inclined surfaces 28, 32 of the guide shoes 26 and the brake shoes 30 cause the brake shoes 30 to move in the direction of the rail until the brake pad 36 contacts the surface of the guide rail 14. As those skilled in the art will appreciate, the brake pad 36 is applied to the rail 14 with a normal force F2 supplied by the spring 24. The amount of braking force applied to the guide rail 14 by the brake shoe 30 is substantially and directly proportional to the friction coefficient between the high friction material used in the brake pad 36 and the material of the rail 14. As braking occurs, heat generated in the brake pad 36 deleteriously affects the friction coefficient between the brake pad 36 and the rail 14. Under excessive heat, a substantial reduction in hardness as well as deformation of the high friction material may occur, ultimately leading to brake failure. In previous applications, the brake pad 36 used in the brake system 10 to provide a friction surface has been formed from gray cast iron. Gray cast iron, while suitable for low speed, low load conditions, cannot operate as a consistent friction material at high speed and load conditions. In other applications, higher cost materials are used as inserts for elevator systems having a greater load and traveling at a greater speed. The above described elevator safety brake system 10 is exemplary and other safety brake systems are considered within the scope of the invention. In addition, the safety brake system 10 could additionally or alternatively be used on the counterweight of the elevator system.

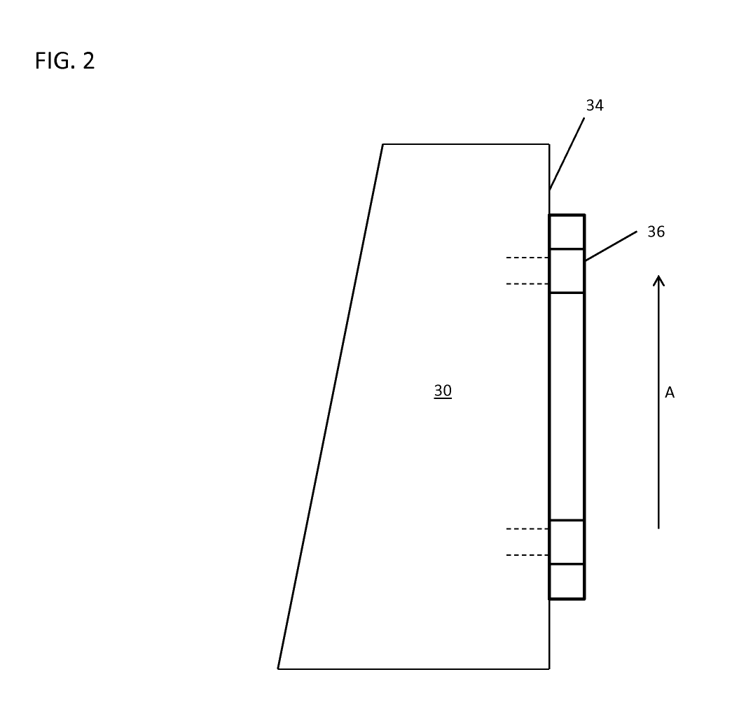

Referring now to FIG. 2, an exemplary brake shoe 30 is illustrated. In one embodiment, at least a portion of a brake pad or friction material insert 36 attached to the surface 34 of the brake shoe 30 facing the rail 14 (FIG. 1) includes a ceramic matrix composite (CMC). An exemplary CMC includes a polymer-based carbon-ceramic composite friction material, such as the Polymer-to-Ceramic Composite (PTCC)™ material manufactured by Starfire Systems for example. The coefficient of friction of a CMC is generally in the range of between about 0.15 and about 0.5. The friction properties of the CMC may be altered by adjusting the formulation of the matrix. In one embodiment the matrix phase of the CMC includes silicon carbide (SiC), silicon oxycarbide (SiOC), and/or carbon (C) based phases and/or the reinforcement phase of the CMC includes silicon carbide (SiC) and/or carbon (C).

The coefficient of friction of the CMC material is also affected by the orientation of the fibers, such as carbon fibers for example, within the matrix. Experimental results indicated that a non-linear relationship exists between the angle of the fiber orientation and the direction of sliding. Multiple friction mechanisms may exist, including adhesion, plastic deformation, plowing, and/or cutting, when the friction material insert 36 is in sliding engagement with rail 14. The direction of the fibers will control how many of these sliding mechanisms occur, and the magnitude of these mechanisms. For example, when the fibers are parallel to the sliding direction, indicated by the direction of arrow A, only some of these friction mechanisms apply and the coefficient of friction is minimized. However, when the fibers are positioned perpendicular to the sliding direction, as illustrated in FIG. 2, more friction mechanisms exist and the coefficient of friction of the CMC is maximized An intermediate orientation (e.g. fibers arranged 30° to the sliding direction) has the same friction mechanisms as the perpendicular orientation, but provides a lower coefficient of friction than the perpendicular orientation (and greater than the parallel orientation). Therefore, if a larger coefficient of friction is desired, such as equal to or greater than 0.3 for example, the fibers should be arranged at an angle (up to perpendicular) to the sliding direction. In one embodiment, the orientation of the fibers in the matrix is controlled throughout the whole thickness of the CMC and not just at the surface that contacts the rail 14 to maintain a generally constant coefficient of friction and to ensure consistent wear.

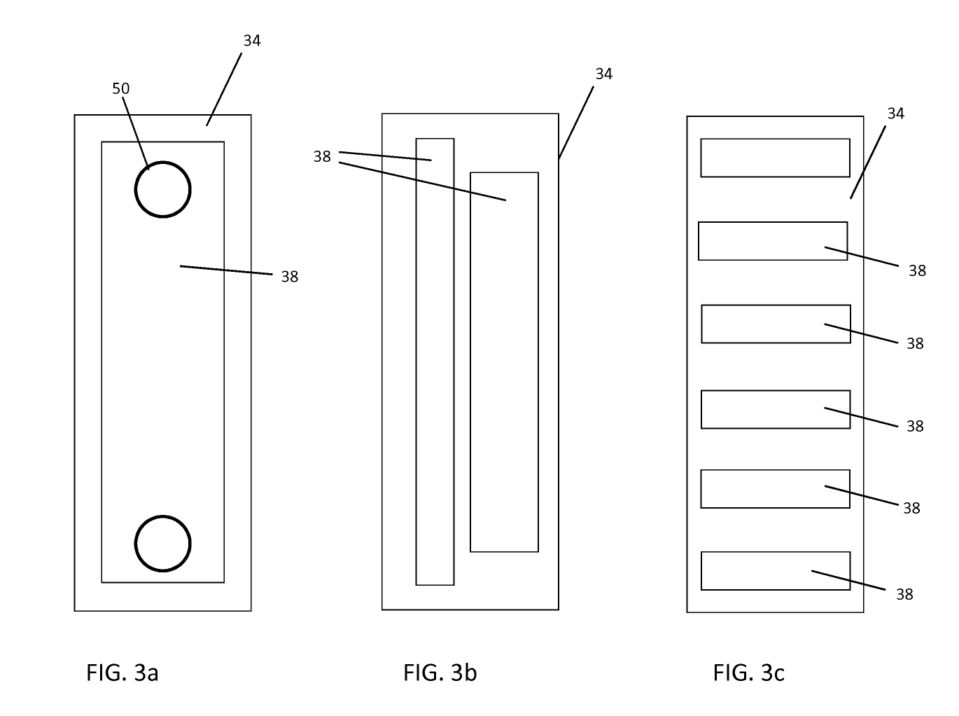

The thickness of the friction material insert 36 can be constant and should be large enough to prevent deformation during operation of the safety brake system 10. In one embodiment, the thickness of the friction material insert 36 is greater than or equal to about 0.25 inches. Referring now to FIG. 3a, the illustrated friction material insert 36 may consist of a single CMC insert 38. Alternately, as shown in FIGS. 3b-3c, the friction material insert 36 may consist of any number of CMC inserts 38. The plurality of CMC inserts 38 attached to the surface 34 of the brake shoe 30 may be identical, or alternately, each CMC insert may have a different length, width and thickness. The dimensions of each CMC insert 38 may be determined from the calculated contact pressure, contact area, contact shear stress and friction force. All CMC inserts 38 attached to a brake shoe 30 may have a uniform thickness to promote equal wear across the plurality of inserts. In one embodiment, the CMC inserts 38 cover the entire rail facing surface 34 of the brake shoe 30. Alternatively, the CMC inserts 38 may cover only a portion of the surface 34 of the brake shoes 30 facing the rail 14. The amount of the surface 34 that the CMC inserts 38 need to cover is dependent on the contact pressure between the CMC inserts 38 and the rail 14 and also the dissipated energy in the system. In one embodiment, the contact pressure is estimated as a function of the loss of speed and the trip speed of the elevator.

The CMC inserts 38 may be attached to the brake shoe 30 using known mechanical or chemical methods. For example, the inserts 38 may be attached to the brake shoe directly via a mechanical fastener 50 or alternatively may be attached to the brake shoe 30 by a braze material interface (not shown). Braze material which may be used in the present invention includes a low melting alloy containing 3 or more metals in powder or foil form. The braze alloy may be selected based on its ability to wet the CMC inserts 38 and the brake shoe 30 and its ability to withstand the operational conditions of the brake. Alternately, chemical methods such as adhesion may be used to attach the CMC inserts 38 and the brake shoe 30. The adhesive may be a heat resistant rubber like material, such as heat resistant silicone for example. Because the CMC inserts are attached to the brake shoe 30 in a manner similar to conventional high friction materials, the CMC inserts 38 may be used in retrofit and modernization applications with pre-existing brake shoes 30.

By using CMC inserts 38 on the surface 34 of the brake shoe 30 facing the rail 14, the durability and performance of the safety system 10 is improved. CMC inserts have a high temperature stability and stable friction performance over a wide temperature range, making them better than conventional high friction materials for elevator applications having speeds of up to about 20 m/s. The CMC inserts can be customized to have a stable coefficient of friction by selecting proper materials and processing methods that additionally allow for quick dissipation of generated heat. By improving the efficiency of the safety brake system 10, the brake shoes 30 can be reduced in size compared to current systems. In addition, by using CMC inserts 38, the manufacturing and replacement costs of the safety brake system 10 are reduced.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A brake element, comprising:
a friction material including a polymer-based ceramic matrix composite material having a plurality of fibers;
wherein the plurality of fibers are arranged at an angle to a braking direction.

2. The brake element according to claim 1, wherein the brake element has a coefficient of friction of greater than or equal to about 0.3, and the angle of the plurality of fibers is about 90°.

3. The brake element according to claim 1, wherein the brake element is an insert on a brake shoe.

4. The brake element according to claim 3, in combination with one or more other brake elements.

5. The brake elements according to claim 4, wherein at least one of the brake elements has a length and/or width different than another brake element.

6. The brake elements according to claim 4, wherein the one or more brake elements have a uniform and equal thickness.

7. The brake element according to claim 3, wherein the friction material is mechanically attached to a first surface of a brake shoe.

8. The brake element according to claim 3, wherein the friction material is chemically attached to a first surface of a brake shoe.

9. The brake element according to claim 1, wherein the polymer-based ceramic matrix composite material includes a matrix phase of a silicon carbide phase, a silicon oxycarbide phase, and/or a carbon phase.

10. The brake element according to claim 1, wherein the polymer-based ceramic matrix composite material includes a reinforcement phase of silicon carbide and/or carbon.

11. The brake element according to claim 1, wherein the brake element is part of an elevator safety brake system for stopping an elevator car or counterweight.

12. A method of making a brake element, comprising the steps of:
providing a friction material including a polymer-based ceramic matrix composite material having a plurality of fibers;
arranging the plurality of fibers at an angle to a braking direction.

13. The method of claim 12, wherein the providing step includes providing a polymer-based ceramic matrix composite material having a matrix phase of a silicon carbide phase, a silicon oxycarbide phase, and/or a carbon phase.

14. The method of claim 12, wherein the providing step includes providing a polymer-based ceramic matrix composite material having a reinforcement phase of silicon carbide and/or carbon.

15. The method of claim 12, wherein the arranging step includes selecting the angle such that the friction material provides a desired coefficient of friction.

16. The method of claim 15, wherein the angle is about 90°.

17. The method of claim 15, wherein the desired coefficient of friction is greater than or equal to about 0.3.
